(19) United States
(12) Patent Application Publication
(10) Pub. No.: US 2005/0219038 A1
(43) Pub. Date: Oct. 6, 2005

(54) Method and system for contactless data transmission

(75) Inventor: Walter Kargl, Graz (AT)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/097,968

(22) Filed: Mar. 31, 2005

(30) Foreign Application Priority Data
Apr. 2, 2004 (DE) 10 2004 016 335.9

(51) Int. Cl. H04Q 5/22

(52) U.S. Cl. 340/10.1; 340/10.51; 340/10.3; 340/10.34; 340/10.4

(57) ABSTRACT

A method and system for contactless data transmission between a read/write device and a transponder driven by the read/write device. The read/write device transmits a trigger pulse to indicate a transmission of modulated data in the transmission and/or reception direction. The transponder generates at least one clock signal when data are received, and the transponder, for the purpose of transmitting modulated data, evaluates a synchronization signal transmitted by the read/write device. The method and system do not use a synchronous system clock.

### CROSS-REFERENCE TO RELATED APPLICATION

This application claims priority to German Patent Application Serial No. 10 2004 016 335.9, filed Apr. 2, 2004, and which is incorporated herein by reference in its entirety.

### FIELD OF INVENTION

The invention relates to a method for contactless data transmission between a read/write device and a transponder driven by said read/write device.

### BACKGROUND OF INVENTION

So-called “RFID” systems (radiofrequency identification) are being used more and more widely. They basically comprise two components, namely a “transponder” and a detection or read/write device. The transponder is attached to an article that is to be identified, the detection device performing this identification contactlessly. The read device typically comprises a radiofrequency module (transmitter and receiver), a control unit and also a coupling element with respect to the transponder. The transponder, which represents the actual data carrier of an RFID system, usually comprises a coupling element and also an electronic component, a so-called chip.

Outside the response range of a read device, the transponder, which generally does not have its own voltage supply, behaves completely passively. The power required for operation of the transponder is transmitted to the transponder contactlessly by the coupling unit.

As is customary in wire-free data transmission, a radiofrequency signal is modulated with the data to be transmitted in the case of an RFID system, too. Such a method is described for example in “Finkenzeller, Klaus; RFID-Handbuch [RFID Handbook], 2nd edition 2000, Karl-Hansa-Verlag Munich, chapters 2 and 6″. The data transmission both in the transmission direction and in the reception direction is controlled using a clock generator that provides a frequency that is greater than or equal to the data frequency. A standard that is currently applicable for this for contactless data carriers or smart cards is ISO 14443 or ISO 15693.

Transponders, such as so-called smart cards for example, increasingly have digital circuit components requiring the presence of a clock signal in their electronic devices. Present-day solutions basically provide two different methods for generating clock signals for the digital circuits. Firstly, the clock may be derived directly from the electromagnetic field. Secondly, a clock is generated in the data carrier itself, for example in a semiconductor chip embedded in the data carrier.

What is disadvantageous about both methods is that the derived clock frequency or the generated clock frequency brings about a high current consumption in the digital circuit components and, moreover, inaccuracies in the clock lead to an asynchronous communication behavior between transmitter and transponder.

The invention is thus based on the object of providing a method and system for contactless data transmission in which the current consumption of digital circuits of the transponder is considerably reduced.

### SUMMARY OF THE INVENTION

The method and system according to the invention for contactless data transmission provides for the data transmission system to realize data transmission in both directions without the use of a synchronous system clock. A data exchange is basically initiated by the read/write device by the read/write device generating a trigger pulse for the purpose of transmitting or for the purpose of receiving data. If data that are modulated onto a radiofrequency carrier, by way of example, are transmitted from the read/write device to the transponder, then the carrier frequency is not used for generating a clock signal, rather the transponder generates the clock frequency from the data signal. The fact that the significantly lower-frequency data clock is used for generating the clock signal enables a considerable reduction of the digital current consumption in the transponder.

For the transmission of data to the read/write device by the transponder, the transponder evaluates a synchronization signal transmitted by the read/write device without the use of a digital clock signal.

### BRIEF DESCRIPTION OF THE DRAWINGS

FIG. 1 shows a clock signal generated from a spectral profile of a modulated data signal;

FIG. 2 shows the sequence of analog time constants started by the transponder as a function of pulses of a data signal transmitted to the transponder; and

FIG. 3 shows the sequence of analog time constants started by the transponder as a function of pulses of a synchronization signal for transmission of a data signal.

### DETAILED DESCRIPTION OF EXEMPLARY EMBODIMENTS OF THE INVENTION

Certain embodiments described herein-below provide for the edges of the data signal to be used for generating the clock. If an edge is detected in the data signal, it is forwarded as a clock signal edge to a circuit integrated in the transponder. No clock is generated for the transmission instants at which no data signal is modulated on the carrier, which has the effect that the circuits integrated in the transponder have no clock for these instants and thus do not bring about a current consumption.

In an advantageous manner, the clock signal may also be generated in such a way that a rising or falling edge of the data signal is evaluated as a clock edge change and is forwarded to the circuit. As a result of this, the generated clock frequency could be halved and a current consumption could be brought about only with the rising or falling edge of the data signal in the circuit of the transponder.

It is particularly advantageous for the transponder, in the event of transmission or reception of data, to code or decode data with the aid of an analog time base. The pulse duration of the received data signal or data signal to be transmitted is merely evaluated. The advantage here resides in the low current consumption of the circuit of the transponder during transmission or reception of data since the digital circuit is not actively clocked.

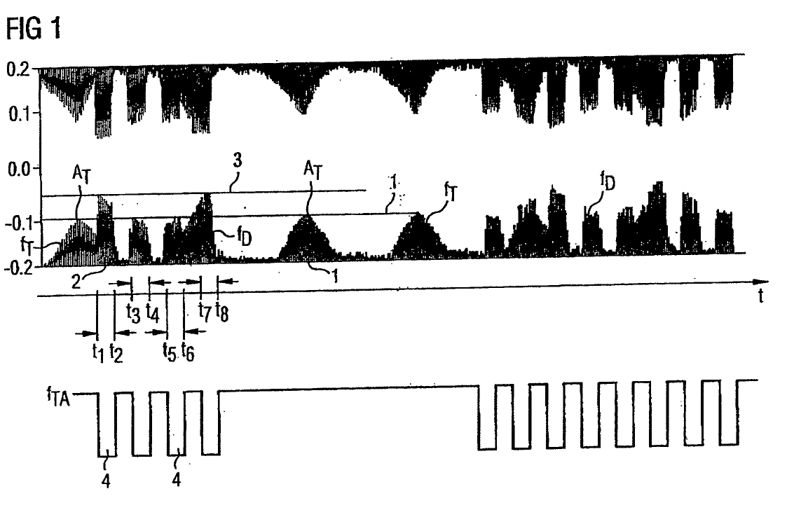

FIG. 1 illustrates a clock signal generated by a transponder, which clock signal has been generated from a data signal. Illustrated above a time axis t is a spectral profile of a radiofrequency carrier signal f_{T}, onto which a low-frequency data signal f_{D} is modulated, both in the transmission direction and in the reception direction with respect to a read station. Firstly, the carrier f_{T} oscillates between two signal levels 1 with an amplitude A_{T}. A modulation oscillation 2 is present at the instant t1, so that the carrier f_{T} assumes an increased signal level 3 starting from the instant t1. With the end of the first modulation oscillation 2 at the instant t2, the signal level 3 of the carrier f_{T} returns to the first signal level 1.

For the reception of data sent by a read station, a transponder samples the modulated data signal f_{D} and generates a clock signal f_{TA}—illustrated below the time axis t—precisely for the instants at which a modulation oscillation is present, the length of a generated clock pulse 4 corresponding to a pulse length of the data signal f_{D} in the time period t1 to t2. Further time intervals t3 to t4, t5 to t6 and t7 to t8 are demonstrated in the concrete exemplary embodiment and illustrate that a corresponding clock pulse 4 is generated for each received data pulse.

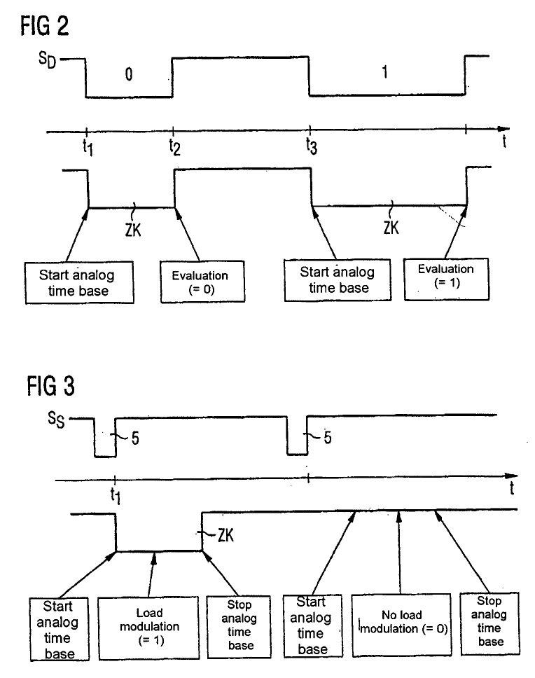

FIG. 2 illustrates the sequence of analog time constants as a function of pulses of the data signal in the event of reception of a data signal by the transponder. A coded data signal S_{D} and, as a function of an edge change, a starting and stopping of an analog time base integrated in the transponder are illustrated one below the other. Modulation oscillations received by the transponder are triggered by the transponder, so that an edge change of the modulated data signal S_{D} is registered proceeding from the instant t1. At the same time as this edge change, the transponder starts an analog time constant Z_{K}, the transponder, after said time constant Z_{K} has elapsed, evaluating again and again, here by way of example at the instant t2, whether the data signal S_{D} has effected a further level change. Finally, a level change in the data signal S_{D} is effected at the instant t3, so that a further time constant Z_{K} is started, the state of the level being evaluated until the next level change. In the present case, the data signal has a level with the value “1” at the instant t3, so that the transponder, in the time period t3 up to an instant tx at which a renewed level change takes place, clocks its internal circuit for this time period and reads in and decodes the data.

FIG. 3 illustrates the sequence of analog time constants started by the transponder as a function of pulses of a synchronization signal for the transmission of a data signal. The read device communicates a synchronization signal Sₛ for the purpose of transmission of data by the transponder. In this exemplary embodiment, the transponder, for the transmission of data, starts an analog time constant Zₖ at the instant t1, that is to say with the falling edge of a synchronization pulse 5, and sends data to the read device for the duration of said time constant Z_{K}.

The method according to the invention enables a considerable amount of current to be saved in the transmission or reception of data since the clock is no longer derived permanently from a carrier frequency or an energy carrier, but rather only at instants at which a data signal is transmitted.

1. A method for contactless data transmission between a read/write device and a transponder driven by said read/write device, the method comprising the steps of:
transmitting a trigger pulse from the read/write device, wherein the trigger pulse indicates a transmission of a modulated data signal in the transmission and/or reception direction;
generating at least one clock signal by the transponder when the modulated data signal is received; and
evaluating a synchronization signal transmitted by the read/write device, wherein the step of evaluating is performed by the transponder for the purpose of transmitting the modulated data signal, and wherein the modulated data signal is transmitted in the transmission and/or reception direction, without use of a synchronous system clock.

2. The method of claim 1, wherein the clock signal is generated from a clock frequency of the modulated data signal.

3. The method of claim 1, wherein the step of generating at least one clock signal utilizes a rising or falling edge of the modulated data signal.

4. The method of claim 1, wherein the step of generating at least one clock signal utilizes a rising or falling edge of the modulated data signal as a clock edge change.

5. The method of claim 1, further comprising the step of initiating, in the transponder, an analog time constant corresponding to a length of a pulse duration of the modulated data signal for reception of the data, by using a rising or falling edge of the transmitted modulated data signal.

6. The method of claim 5, further comprising the step of evaluating whether an edge change of a pulse of modulated data signal has occurred after the analog time constant has elapsed.

7. The method of claim 1, further comprising the step of initiating an analog time constant for transmitting the data signal to the read/write device when a rising edge of the synchronization signal is present.

8. A system for performing contactless data transmission, the system comprising:
a read/write device that transmits electromagnetic energy, the electromagnetic energy including a trigger pulse indicating that the read/write device is to transmit a data signal;
a transponder powered by the electromagnetic energy received from the read/write device; and
clock generating circuitry housed in the transponder for generating at least one clock signal when the data signal is received from the read/write device,
wherein the clock generating circuitry creates a non-synchronous clock signal from a modulating characteristic of the data signal transmitted by the read/write device.

9. The system of claim 8, wherein the read/write device comprises circuitry for generating a synchronization signal, and wherein the transponder includes circuitry for reading and using the synchronization signal to control transmission of data in an electromagnetic format from the transponder to the read/write device.

10. The system of claim 8, wherein the transponder comprises circuitry for initiating an analog time constant, which corresponds to a length of a pulse duration of the data signal, using an edge of the data.

11. A method for generating a clock signal in a data transmitting device, the method comprising the steps of:
receiving a trigger pulse of electromagnetic energy;
receiving a first modulated data signal in the form of electromagnetic energy; and
generating a clock signal in response to receiving the trigger pulse and the first modulated data signal,
wherein the clock signal is non-synchronous and the characteristics of the clock signal are based upon an edge of the first modulated data signal.

12. The method of claim 11, further comprising the steps of:
accepting a synchronization signal; and
transmitting a second modulated data signal,
wherein the accepting and transmitting steps do not utilize a synchronous system clock.

13. The method of claim 11, further comprising steps of:
generating an analog time constant corresponding to a length of a pulse duration of the modulated data signal; and
utilizing the analog time constant to regulate the step of receiving a first modulated data signal.

14. The method of claim 11, wherein the trigger pulse and the first modulated data are sent by a read/write device in the form of electromagnetic energy.

15. The method of claim 11, wherein the transponder is a radiofrequency identification device.

16. The method of claim 12, further comprising the steps of:
detecting a rising edge of the synchronization signal;
initiating an analog time constant when the detecting step returns a positive result; and
utilizing the analog time constant to perform the step of transmitting a second modulated data signal.

17. An RFID (Radio Frequency Identification Device) comprising:
a coupling element that receives electromagnetic energy including a trigger pulse and a first modulated data signal; and
a microprocessor chip programmed to generate a clock signal in response to receiving the trigger pulse and the first modulated data signal from the coupling element,
wherein the clock signal is non-synchronous and the characteristics of the clock signal are based upon an edge of the first modulated data signal.

18. The RFID of claim 17, wherein the RFID does not utilize a synchronous system clock.

19. The RFID of claim 18, wherein the coupling element receives the electromagnetic energy from a read/write device, the read/device being programmed to retrieve data stored on the RFID.

20. An RFID (Radio Frequency Identification Device) comprising circuitry for uploading data in an electromagnetic format to a read/write device, wherein the RFID does not include a synchronous system clock.

21. A system for contactless data transmission between a read/write device and a transponder driven by said read/write device, comprising:
means for transmitting a trigger pulse from the read/write device, wherein the trigger pulse indicates a transmission of a modulated data signal in the transmission and/or reception direction;
means for generating at least one clock signal by the transponder when the modulated data signal is received; and
means for evaluating a synchronization signal transmitted by the read/write device for the purpose of transmitting the modulated data signal, wherein the modulated data signal is transmitted in the transmission and/or reception direction, without use of a synchronous system clock.

22. A system for performing contactless data transmission, the system comprising:
a read/write means for transmitting electromagnetic energy, the electromagnetic energy including a trigger pulse indicating that the read/write device is to transmit a data signal;
a transponder means powered by the electromagnetic energy received from the read/write device; and
clock generating means housed in the transponder for generating at least one clock signal when the data signal is received from the read/write device,
wherein the clock generating means creates a non-synchronous clock signal from a modulating characteristic of the data signal transmitted by the read/write means.

23. A system for generating a clock signal in a data transmitting device, method comprising:
means for receiving a trigger pulse of electromagnetic energy;
means for receiving a first modulated data signal in the form of electromagnetic energy; and
means for generating a clock signal in response to receiving the trigger pulse and the first modulated data signal,
wherein the clock signal is non-synchronous and the characteristics of the clock signal are based upon an edge of the first modulated data signal.
